(19) United States
(12) Patent Application Publication
(10) Pub. No.: US 2006/0013951 A1
(43) Pub. Date: Jan. 19, 2006

(54) Coater and method for producing coated sgeet and air floating mini-turn bar

(76) Inventors: Kenji Yamada, Hiroshima-ken (JP); Chizuka Yamada, Hiroshima-ken (JP); Masahiro Sugihara, Hiroshima-ken (JP); Hiroshi Miura, Hiroshima-ken (JP); Toshiaki Miyakura, Hiroshima-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/506,511

(22) PCT Filed: Mar. 4, 2003
(86) PCT No.: PCT/JP03/02481

§ 371 Date: Jun. 21, 2005

(30) Foreign Application Priority Data
Mar. 5, 2002 (JP) 2002-59250
Oct. 30, 2002 (JP) 2002-316494

(51) Int. Cl. B05D 1/00; B05C 1/00; B05D 5/00

(52) U.S. Cl. 427/211; 118/200

(57) ABSTRACT

In an apparatus for applying a film of coating solution to each side of a web such as paper, resin film, etc., there is provided an air-flotation type mini turn bar (4) to the downstream side of the nipping portions (20) of two applicator rolls (2,2). The air-flotation type mini turn bar (4) is used to convey the web (1) while holding the web on the surface of one of the two applicator rolls (2), after it passes between the nipping portions (20). In this way, the occurrence of flaws in the coated surfaces of the web (1) is prevented, the occurrence of a mist and coating unevenness is suppressed, and a film of coating solution is formed evenly on each side of the web.

### TECHNICAL FIELD

The present invention relates to an apparatus and method, which are used in paper-making machines, resin-film manufacturing machines, etc., for applying a coating solution to the surface of a web such as paper, resin film, etc., and also relates to an air-flotation type mini turn bar that is suitably used in the coating apparatus.

### BACKGROUND ART

In paper-making machines, resin-film manufacturing machines, etc., there is provided an apparatus for applying a coating solution to the surface of a web such as paper, resin film, etc.

FIG. 14 is a simplified side view showing a conventional coating apparatus. As illustrated in the figure, a web 1, such as paper, etc., is fed from a previous step and passes between the web-nipping portions 20 of two applicator rolls 2 which are formed when they are pressed against each other. After the web 1 is coated with a coating solution, it goes into a drier 6 via a turn bar (air-flotation/non-contact type web-travel supporting unit) 5 that conveys the web 1 while floating it.

The application of a coating solution to both sides of the web 1 is performed as follows:

Each applicator roll 2 includes a main body 2a made of metal such as steel, etc. The roll main body 2a has an elastic film 2b such as a film of rubber on the outer periphery. Each applicator roll 2 rotates at the same circumferential speed as the travel speed of the web 1. The applicator roll 2 is equipped with a coater head 3, which is a means of supplying a coating solution to the surface of the elastic film 2b.

The coater head 3 contains measurement means such as a coating solution supply passage, measuring rod, blade, etc. After a sufficient quantity of coating solution is supplied from the coater head 3 to the surface of the applicator roll 2, at the exist of the coater head the measuring rod is pressed against the surface of the applicator roll 2 to form a film of coating solution with a predetermined thickness on the surface of the applicator roll 2.

Note that the film thickness of the coating solution on the applicator roll 2 is adjusted by controlling the force of pressing the measuring rod or blade against the applicator roll 2. The technique of forming a film of coating solution on the applicator roll 2, described above, is well known in the prior art (see, for example, Y. Miura, “Trend of the Latest Coater-Size Press Technique,” Paper-Pulp Technique Times, No. 12, 1997) and is not particularly limited.

A film of coating solution formed on each of the applicator rolls 2 by the above-described technique is transferred and applied to each side of the web 1 as it passes between the web-nipping portions 20 of the applicator rolls 2 which are formed when they are pressed against each other.

The web 1 with a film of coating solution transferred and applied to each side is conveyed to a drier 6. At this time, as shown in FIG. 14, if the coating solution, transferred and applied from the applicator rolls 2 to the web 1, is in an undried state and contacts a solid object such as a conveyance roll during conveyance, the coated surface will be flawed and the quality will be considerably degraded. Because of this, in the web conveyance between the web-nipping portions 20 of the applicator rolls 2 and drier 6, there is used an air floater, or a turn bar 5 called a non-contact type guide member.

The non-contact type guide member 5 is used to support and convey the web 1 without contacting the web surface by floating the web 1 with the force of air. Therefore, the web 1 can be conveyed to the drier 6 without degrading the quality of the coated surface in an undried state, formed on the surface of the web 1.

Now, a description will be given of problems found in the above-described conventional technique.

In the case where the web 1 is paper that absorbs water, water absorption sometimes causes elongation and shrinkage of the web 1, if a coating solution is transferred and applied to the web 1. Also, in the case where the web 1 is resin film, etc., and is elongated or shrunk by the temperature of a coating solution, elongation and shrinkage sometimes occurs in the web 1, if a film of coating solution is transferred and applied to each side of the web 1 at the web-nipping portions 20 of the applicator rolls 2.

On the other hand, the above-described conventional technique, as shown in FIG. 14, does not have any device that regulates the path of the web 1 between the web-nipping portions 20 of the applicator rolls 2 and the turn bar 5.

Therefore, in the case where there occurs elongation and shrinkage in the web 1, and the web 1 is elongated particularly at the exist of the web-nipping portions 20, the web 1 sometimes travels while sticking to the surface of one of the upper and lower applicator rolls 2 because of the stickiness of a coating solution, as shown in FIG. 15.

When the web 1 is wide (in the width direction of the applicator roll 2), the state of sticking becomes uneven in the width direction of the web 1. That is, one portion of the web 1 in the web width direction sticks to the upper applicator roll 2, while another portion sticks to the lower applicator roll 2. Therefore, there are cases where the web 1 vibrates between the surfaces of the upper and lower applicator rolls 2.

In the case where coating operations are performed at high speeds, there are cases where the state of uneven sticking starts to fluctuate temporally and becomes unstable. This phenomenon is disclosed, for example, in Japanese Laid-Open Patent Publication No. HEI 7-163924.

When the position and angle at which the web 1 is separated from the applicator roll 2 are uneven and unstable, there are cases where coating unevenness, called peeling patterns such as that shown by reference numeral 11 in FIG. 16, take places in the coated film on the web 1. This phenomenon is, for example, the same as that shown in FIGS. 4 and 8 of Japanese Patent No. 2578183.

The above-described phenomenon is considered to take place for the following reasons: when the coating solution between the surface of the web 1 and the surface of the applicator roll 2 is split between the applicator roll side and the web surface side after the web 1 passes between the web-nipping portions of the applicator rolls 2, the meniscus of the split solution becomes unstable; as a result, the transfer rate of the coating solution that is transferred from the applicator roll 2 to the web surface becomes temporally and spatially unstable; and the film thickness of the coating solution formed on the web surface becomes uneven.

In addition to the peeling patterns, there is a fear of a misting phenomenon occurring. That is, in the case of high-speed coating operations, a coating solution scatters in drops because of the above-described meniscus unstableness. If this phenomenon takes place, the coating apparatus and coated paper will be stained with a coating solution and there will be a possibility of operations being suspended.

The present invention has been made in view of the circumstances described above. Accordingly, it is the object of the present invention to provide a coating apparatus and coating method which are capable of evenly forming a film of coating solution on each side of a web by suppressing the occurrence of a mist and coating unevenness, while preventing the occurrence of flaws in the coated surfaces.

### DISCLOSURE OF THE INVENTION

To achieve this end, there is provided an apparatus that transfers and applies a film of coating solution on each of two applicator rolls to each side of a web as it passes between web-nipping portions of the two applicator rolls which are formed when they are pressed against each other. The apparatus includes an air-flotation type mini turn bar, which is provided to the downstream side of the web-nipping portions. The air-flotation type mini turn bar is used to convey the web while holding the web on the surface of one of the two applicator rolls, after the web passes between the web-nipping portions.

According to the coating apparatus of the present invention, the air-flotation type mini turn bar is able to convey the web while holding the web on the surface of one of the two applicator rolls, after the web passes between the web-nipping portions. By forcibly holding the web on the surface of one of the two applicator rolls, the position at which the web is separated from the applicator roll becomes stable. For instance, the occurrence of coating unevenness called peeling patterns can be prevented, and consequently, coating quality can be considerably enhanced.

Preferably, the coating apparatus of the present invention further includes a mechanism that moves the mini turn bar. Preferably, the mini-turn-bar moving mechanism is constructed to adjust the distance that the wed is held on one of the two applicator rolls, or adjust the distance between the one applicator roll and the mini turn bar. By providing the mini-turn-bar moving mechanism, the separation of the web from one of the two applicator rolls and the application of a coating solution from the one applicator roll to the web can be adjusted.

Preferably, the coating apparatus of the present invention further includes a paper roll, which is provided to the upstream side of the web-nipping portions. The paper roll is used to convey the web while holding the web on the surface of the other of the two applicator rolls, before the web passes between the web-nipping portions. By providing the paper roll, the application of a coating solution from the other applicator roll to the web can be suitably adjusted.

In this case, the coating apparatus of the present invention preferably includes a mechanism that moves the paper roll. By providing the paper-roll moving mechanism (position adjustment mechanism), the application of a coating solution from the other applicator roll to the web can be suitably adjusted.

In accordance with the present invention, there is provided an air-flotation type mini turn bar that causes a web to travel so as to form an arcuately curved portion around the bar by floating the web with air. The air-flotation type mini turn bar includes a first air pocket arranged inside the arcuately curved portion of the web; a second air pocket provided adjacent to the first air pocket and arranged near an entrance portion of the curved portion; a third air pocket provided adjacent to the first air pocket and arranged near an exit portion of the curved portion; a first air nozzle provided between the first air pocket and the second air pocket for squirting air toward the web; and a second air nozzle provided between the first air pocket and the third air pocket for squirting air toward the web.

According to the above-described air-flotation type mini turn bar, the bottom surface of the curved portion of the web can be stably supported by both the dynamic pressure of air squired from each of the air nozzles and the static pressure of air within each of the air pockets, and the web is able to travel so as to form an arcuately curved portion around the mini turn bar without being contacted by the mini turn bar. Therefore, in the case where the web is coated paper, there is no possibility that the coated surfaces of the web will contact the mini turn bar, and the problem of flaws in coated surfaces can be prevented.

Preferably, the air-flotation type mini turn bar further includes a third air nozzle that squirts higher-pressure air than atmospheric pressure into the first air pocket. According to the third air nozzle, the static pressure within the first air pocket is made higher. This can compensate for a reduction in the dynamic pressure component of the wake air in the partition wall portion between air pockets, particularly the first air pocket and third air pocket. Therefore, the web and partition wall portion can be prevented from contacting each other because of negative pressure.

Preferably, a shape from the second air pocket to the third air pocket is formed symmetrically with respect to the center line of the first air pocket. According to this shape, the web can travel along a path having a fixed radius of curvature and stable web travel becomes possible.

Furthermore, the air-flotation type mini turn bar preferably adopts a labyrinth structure. That is, the air-flotation type mini turn bar further includes a plurality of first baffle walls, which are provided in the direction of the width of the web within the first air pocket so that the first air pocket is segmented into a plurality of sections. Also, the air-flotation type mini turn bar includes a plurality of second baffle walls and a plurality of third baffle walls. The second baffle walls are provided in the direction of the width of the web within the second air pocket so that the second air pocket is segmented into a plurality of sections. The third baffle walls are provided in the direction of the width of the web within the third air pocket so that the third air pocket is segmented into a plurality of sections. According to this labyrinth structure, the web can be supported by the static pressure within each section. Therefore, even when the web shifts in the width direction, a fluctuation in the supporting pressure is slight. Also, since each baffle wall is resistant to the wake air, the interior static pressure becomes higher. Therefore, according to such a labyrinth structure, the web can be more stably supported and the web can be prevented from vibrating and making a noise.

Preferably, the second air nozzle includes a second air-jet surface and a second slit-shaped air-jet groove, which are provided on a third surface extending in the direction of the width of the web. The second air-jet surface has a great number of air-jet bores and is provided near the first air pocket. The second air-jet groove extends in the direction of the width of the web and is provided near the third air pocket.

The structure of the second air nozzle can reliably prevent contact of the web at the baffle wall portion between the first air pocket and third air pocket where contact with the web is liable to occur because of a reduction in the dynamic pressure component of the wake air. Preferably, the first air nozzle has the same structure as the second air nozzle. That is, the first air nozzle includes a first air-jet surface and a first slit-shaped air-jet groove, which are provided on the third surface extending in the direction of the width of the web. The first air-jet surface has a great number of air-jet bores and is provided near the first air pocket. The first air-jet groove extends in the direction of the width of the web and is provided near the second air pocket.

### BRIEF DESCRIPTION OF THE DRAWINGS

The present invention will be described in further detail with reference to the accompanying drawings wherein:

FIG. 1 is a simplified side view showing a coating apparatus constructed in accordance with a first embodiment of the present invention;

FIG. 2 is a simplified side view showing a mini turn bar constructed in accordance with the first embodiment of the present invention;

FIG. 3A is a simplified sectional view showing an example of the mini turn bar of the first embodiment;

FIG. 3B is a simplified sectional view showing another example of the mini turn bar of the first embodiment;

FIG. 4 is a simplified side view showing a coating apparatus constructed in accordance with a second embodiment of the present invention;

FIG. 5 is a simplified side view showing a coating apparatus constructed in accordance with a third embodiment of the present invention;

FIG. 6 is a simplified side view showing an alteration of the coating apparatus constructed in accordance with the third embodiment of the present invention;

FIG. 7 is a simplified sectional view showing a first mini turn bar that is preferable in structure to the mini turn bar of the first embodiment;

FIG. 8 is a simplified sectional view showing a second mini turn bar that is preferable in structure to the mini turn bar of the first embodiment;

FIG. 9 is a simplified sectional view showing a third mini turn bar that is preferable in structure to the mini turn bar of the first embodiment;

FIG. 10 is a simplified sectional view showing a fourth mini turn bar that is preferable in structure to the mini turn bar of the first embodiment;

FIG. 11 is a simplified sectional view showing a fifth mini turn bar that is preferable in structure to the mini turn bar of the first embodiment;

FIG. 12A is a simplified sectional view showing a sixth mini turn bar that is preferable in structure to the mini turn bar of the first embodiment;

FIG. 12B is a plan view of the mini turn bar seen from A direction of FIG. 12A and denotes the baffle plate by hatching for distinction;

FIG. 13 is a simplified sectional view showing a seventh mini turn bar that is preferable in structure to the mini turn bar of the first embodiment;

FIG. 14 is a simplified side view showing a conventional coating apparatus;

FIG. 15 is a simplified side view of web-nipping portions used to explain problems found in the conventional coating apparatus; and

FIG. 16 is a simplified plan view of a web used to explain problems found in the conventional coating apparatus.

### BEST MODE FOR CARRYING OUT THE INVENTION

Embodiments of the present invention will hereinafter be described with reference to the drawings.

### (A) First Embodiment

First, a first embodiment of the present invention will be described in conjunction with the drawings.

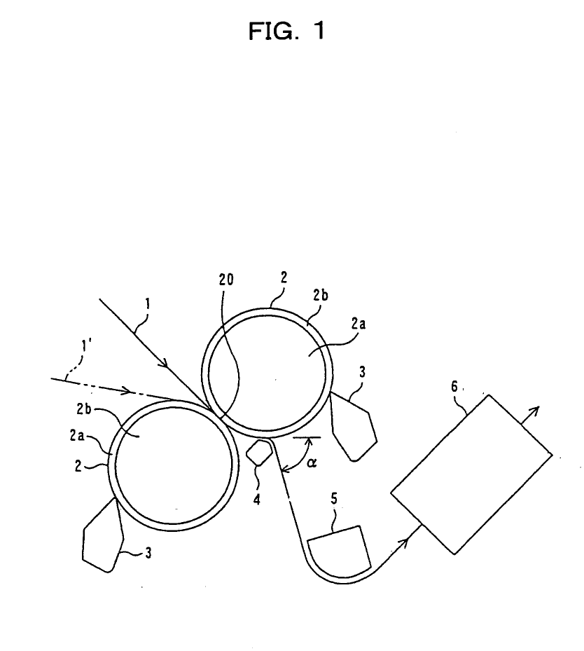

As illustrated in FIG. 1, a coating apparatus is equipped with two applicator rolls 2, 2, which are arranged opposite each other so as to form web-nipping portions 20 when they are pressed against each other. A film of coating solution, supplied to each of the applicator rolls 2,2 by a coater head 3, is transferred and applied to each side of a web 1 as it passes between the web-nipping portions 20. The coated web 1 is guided without being contacted by a turn bar (air-flotation/non-contact type web-travel supporting unit) 5 and goes into a drier 6. Each applicator roll 2, as with the above-described conventional applicator roll, includes a main body 2a made of metal such as steel, etc. The roll main body 2a has an elastic film 2b such as a film of rubber on the outer periphery.

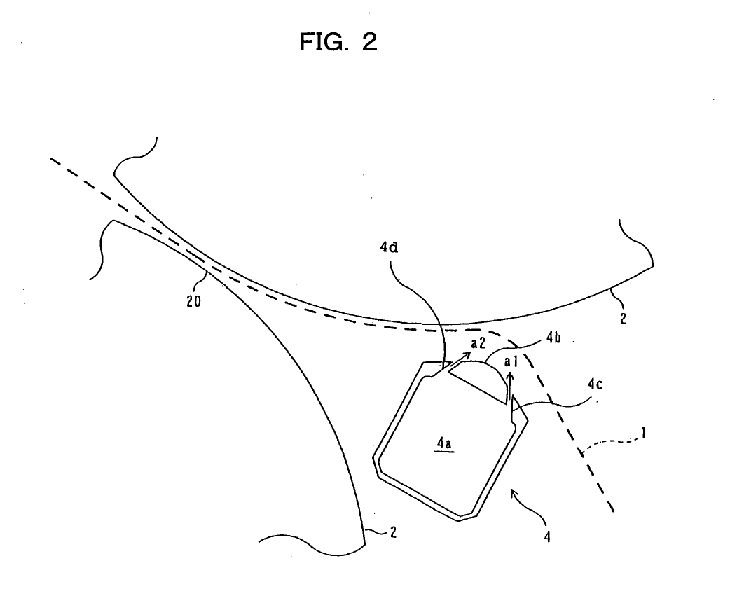

The coating apparatus, as illustrated in FIGS. 1 and 2, further includes an air-flotation type mini turn bar 4 (which is an air-flotation/non-contact type web-travel support unit and smaller in size than the turn bar 5, and which will hereinafter be referred to simply as a mini turn bar). The mini turn bar 4 functions as a web-separating unit and is arranged in close proximity to a portion of one of the two applicator rolls 2 (e.g., the upper applicator roll 2 in the first embodiment) which is downstream from the web-nipping portion 20. The mini turn bar 4 is used to convey the web 1 while holding it on the surface of the upper applicator roll 2. In this way, the position at which the web 1 with a film of coating solution is separated from the upper applicator roll 2 is stabilized, and the web-separating position is kept constant in the direction of the width of the web 1.

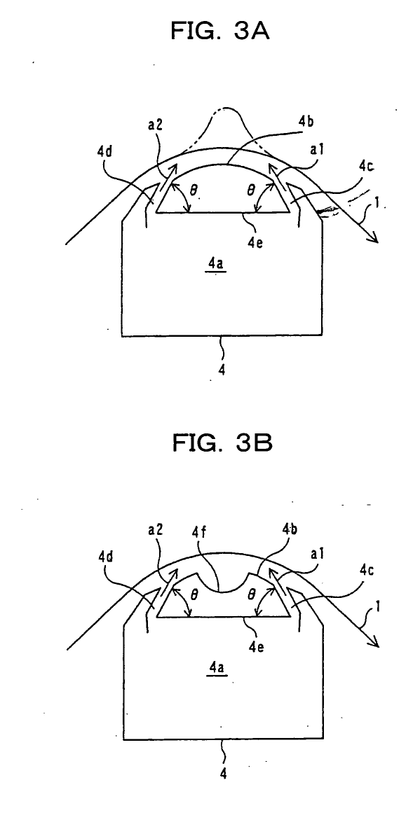

This mini turn bar 4 has, for example, a cross section such as that shown in FIGS. 2 and 3A and extends in the width direction of the web 1. The mini turn bar 4 is equipped with an internal space (flow passageway) 4a to which compressed air is supplied, a guide surface 4b disposed opposite the web 1, and nozzles 4c, 4d provided in the guide surface 4b. The nozzles 4c, 4d are used to squirt the compressed air within the interior space 4a toward the web 1.

With this arrangement, the mini turn bar 4 presses the web 1 toward the surface of the upper applicator roll 2 without contacting the web 1 by the compressed air squirted from the nozzles 4c, 4d. That is, the path of the web 1 is directed toward the upper applicator roll side by the mini turn bar 4.

As a result, the web 1 contacts the surface of the upper applicator roll 2 a little longer, but since the angle α at which the web 1 is separated from the upper applicator roll 2 becomes greater, the position at which the web is separated becomes stable.

That is, as shown in FIGS. 1 and 2, by arranging the mini turn bar 4, the web 1 from the web-nipping portions 20 of the applicator rolls 2 travels while it is being held on the surface of the upper applicator roll 2. And at the position of the mini turn bar 4, the web 1 is forcibly separated toward the position of the turn bar 5. At this time, the mini turn bar 4 creates a layer of air between the web 1 and the guide surface 4b of the mini turn bar 4. Since this layer of air prevents the surface of the coated web 1 from contacting the mini turn bar 4, degradation in the quality of the coated web 1 is prevented.

To create a layer of air between the guide surface 4b of the mini turn bar 4 and the web 1, the guide surface 4b facing the web 1 is provided with nozzles 4c, 4d. Also, the surface 4b facing the web 1 is formed as an air-jet guide surface that has a smoothly curved cross section.

The nozzles 4c, 4d are constructed as a great number of holes juxtaposed in the longitudinal direction of the mini turn bar 4, or they are constructed as two slits extending in the longitudinal direction, or they are constructed as a combination of such holes and slits.

Also, in the first embodiment, the nozzles 4c, 4d are provided on the front side (downstream side in the traveling direction of the web 1) and rear side (upstream in the traveling direction of the web 1) of the guide surface 4b, respectively. The nozzles 4c, 4d are constructed to squirt compressed air in the directions of arrows a1 and a2, respectively. This is for the purpose of creating a stable layer of air between the guide surface 4b and the web 1 and stably causing the path of the web 1 to be close to one of the two applicator rolls 2.

To stably cause the path of the web 1 to be close to one of the two applicator rolls 2, it is effective not only to squirt compressed air toward the web 1, but also to create a stable layer of air between the web guide surface 4b and the web 1 so that air is stored between the web guide surface 4b and the web 1. If both nozzles 4c, 4d are actuated, air is stored between the guide surface 4b and the web 1 and a stable layer of air can be created between the guide surface 4b and the web 1. Hence, the nozzles 4c, 4d are formed in the front and rear portions of the guide surface 4b, respectively.

To effectively utilize the energy of the squirted air for floating the web 1 off the guide surface 4b, it is preferable that the air-jet angle θ of each of the nozzles 4c, 4d (i.e., the angle of the air-jet direction relative to the reference surface 4e of the mini turn bar 4) be within a predetermined range (e.g., a range of approximately 15 to 90 degrees).

That is, if the air-jet angle θ becomes 90 degrees or greater, the greater part of a flow of air from each of the nozzles 4c, 4d will flow out of the front and rear portions of the guide surface 4b. As a result, the force acting on the web 1 is greatly reduced, the force of pressing the web 1 toward the upper applicator roll 2 becomes weak, and it becomes difficult to cause the web 1 to move along a predetermined path.

On the other hand, if the air-jet angle θ is too small (e.g., less than 15 degrees), the force of pressing the web 1 toward one of the two applicator rolls 2 is similarly weakened, it becomes difficult to cause the web 1 to move along a predetermined path, and there is a possibility that the web 1 will come into contact with the mini turn bar 4.

Note that even if the air-jet force that acts on the web 1 is weak, it is possible to cause the web 1 to move along a predetermined path by lowering web tension. However, in this case, as shown by a two-dot chain line in FIG. 3A, the web 1 bulges out in the vicinity of the central portion of the guide surface 4b, and consequently, the web 1 cannot travel smoothly. Therefore, web tension cannot be lowered greatly, and if the air-jet force acting on the web 1 is weak, it is fairly difficult to cause the web 1 to move along a predetermined path.

Thus, it is preferable that the angle of the air-jet direction of each of the nozzles 4c, 4d relative to the reference surface 4e be within a predetermined range (e.g., a range of approximately 15 to 90 degrees).

Also, for the position at which the web 1 is separated from the surface of the upper applicator roll 2 to be stable and constant in the width direction of the web 1, it is preferable to set the radius R of curvature of the front surface (guide surface) 4b of the mini turn bar 4 within a predetermined range (e.g., a range of 20 to 400 mm). And it is also preferable to cause the web 1 to travel along a path curved so as to correspond to the radius R of curvature.

Note that an optimum value for the radius R of curvature of the guide surface 4b (which corresponds to the radius of the path of the web 1 at the position of the guide surface 4b) varies with the layout of a roll, drier, etc., and web tension. The optimum value also varies with the viscosity of a solution that is applied to the web 1 by the coater head 3. For example, when the viscosity of a solution is low and there is no need to separate the web 1 from the surface of the applicator roll 2 abruptly, the radius R of curvature may be great. However, when the viscosity of a solution is high and the web 1 needs to be separated from the surface of the applicator roll 2 abruptly, the radius R of curvature has to be small.

In addition to the radius R of curvature of the guide surface 4b, it is preferable to optimally set the specification of the mini turn bar 4, such as the air-jet angle and air-jet strength of the nozzles 4c and 4d, etc., in accordance with the viscosity of a solution to be applied to the web 1, web tension, and layout of each element.

Note that there is a relation of P=T/R between the radius R of curvature, the tension T of the web 1, and the pressure P applied to the web 1 by the nozzles 4c, 4d. The radius R of curvature, web tension T, and pressure P (air-jet angle θ and air-jet strength of the nozzles 4c, 4d) are set so as to meet the above-described relation.

As shown in FIG. 3B, the guide surface 4b of the mini turn bar 4 facing the web 1 may be provided with a concave static pressure pocket 4f. By reliably holding a jet of air on the guide surface 4b by the static pressure pocket 4f, the jet of air can be effectively utilized for floating the web 1 off the mini turn bar 4. That is, the energy of air squirted from the nozzles 4c, 4d can be effectively converted into pressure that presses the web 1 toward one of the two applicator rolls 2.

Since the coating apparatus of the first embodiment of the present invention is constructed as described above, the application of a coating solution to the web 1 is performed in the following steps (method of applying a coating solution to the web 1, constructed in accordance with the first embodiment).

That is, the web 1 is fed into the coating apparatus from a previous step, and a coating solution is applied to each side of the web 1 at the web-nipping portions of the upper and lower applicator rolls 2. At this time, a film of coating solution is formed on each side of the web 1. The coated web 1 is conveyed to the turn bar 5 and drier 6.

In the coating apparatus and method of the first embodiment, the web 1 first passes between the web-nipping portions 20. Then, the web 1 travels while it is being held on the surface of one (upper) of the two applicator rolls 2 by a predetermined circumferential length by the mini turn bar 4. Next, the web 1 is forcibly separated from the upper applicator roll 2 along the guide surface 4b of the mini turn bar 4.

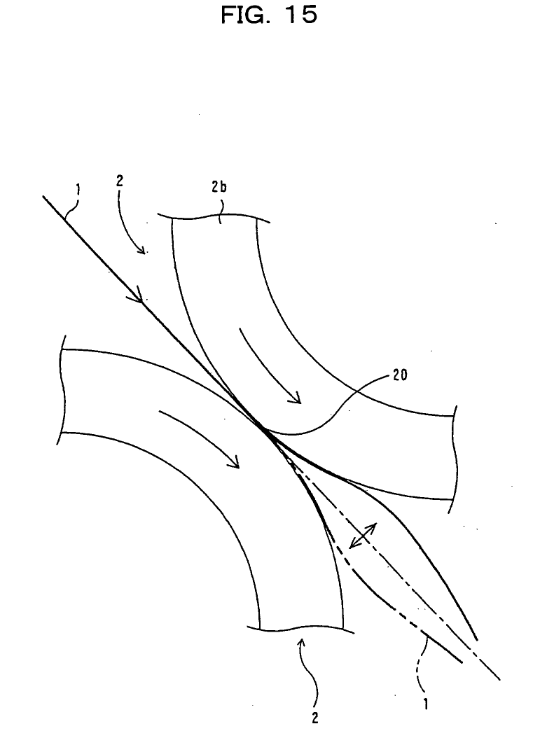

That is, by air squirted from the nozzles 4c, 4d of the mini turn bar 4, the path of the web 1 from the web-nipping portions 20 toward the turn bar 5 is forcibly pushed toward the surface of one (upper) of the two applicator rolls 2 so that the web 1 is brought into contact with the surface of the one applicator roll 2 for a long time and that the angle α at which the web 1 is separated from the surface of the one applicator roll 2 becomes great. Generally, if the angle α at which the web 1 is separated is small, the web 1 is liable to vibrate at the position where the web is separated (see FIG. 15), and therefore the position at which the web 1 is separated becomes unstable. Conversely, if the angle α at which the web 1 is separated is great, the web 1 is less liable to vibrate and therefore the position at which the web 1 is separated becomes stable.

Further, since the position at which the web 1 is separated becomes stable, a meniscus, which is formed as a film of coating solution is split between the applicator roll side and the web surface side, becomes stable and the occurrence of a mist can be suppressed.

Thus, in the coating apparatus of the first embodiment, the separation angle α of the web 1 from the applicator roll 2 becomes greater by being guided along the mini turn bar 4, the separation position of the web 1 from the applicator roll 2 becomes stable and becomes constant in the width direction of the web 1, and the occurrence of a mist can be suppressed.

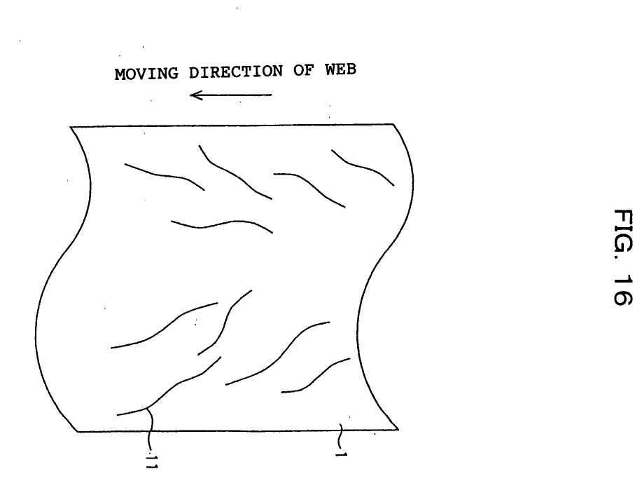

Hence, coating unevenness, called peeling patterns such as that shown in FIG. 16, and a mist, which are found in prior art, can be prevented from occurring in the coated film on the web 1.

Of course, because the mini turn bar 4 is of an air-flotation type, there is no possibility that the surface of the web 1 with a film of coating solution will make contact with the mini turn bar 4 and degrade the coating quality.

Thus, the occurrence of coating unevenness and a mist in the web 1 can be prevented, while preventing the occurrence of a flaw in the coated surfaces of the web 1. Therefore, the formation of an even film of coating solution becomes possible and the coating quality and operating environment are greatly enhanced.

Also, by setting the angle θ of the air-jet direction of each of the nozzles 4c, 4d within a predetermined range (e.g., a range of approximately 15 to 90 degrees), the energy of an air jet can be efficiently utilized for floating the web 1 off the guide surface 4b and there is no possibility that the web 1 will bulge out at the central portion thereof (see the two-dot chain line in FIG. 3A). The path of the web 1 is reliably altered by the mini turn bar 4, so the separation position of the web 1 from the applicator roll 2 can be stabilized.

As shown in FIG. 3B, if the guide surface 4b of the mini turn bar 4 is provided with the static pressure pocket 4f, the energy of a jet of air can be more efficiently converted into pressure that floats the web 1 off the guide surface 4b. As a result, the flotation of the web 1 by the mini turn bar 4 (toward one of two applicator rolls 2) can be reliably performed.

In the first embodiment, the contact (contact distance) of the web 1 with one (upper) of the two applicator rolls 2 becomes longer, so coating conditions for both sides of the web 1 will differ. Because of this, as shown by reference numeral 1′ and a two-dot chain line in FIG. 1, the angle at which the web 1 enters between the web-nipping portions 20 can be adjusted so that the contact of the web 1 with the other (lower) applicator roll 2 becomes longer. In this way, coating conditions for both sides of the web 1, particularly the capillary osmotic conditions of a coating solution into the web 1 (base paper) can be made equal. Also, the quantities of a coating solution that are applied to both sides of the web 1 can be balanced as the coating conditions required for each side of the web 1. In this case, the coating apparatus may further include a guide roll (paper roll) 7, which is arranged to the upstream side of the web-nipping portions 20 to adjust the angle at which the web 1 enters between the web-nipping portions 20.

Note that by permeating a coating solution into the web 1 while holding it on the surface of the applicator roll 2, as described above, the thickness of the coating solution in the meniscus is reduced. At the same time, a rise in the concentration of the coating solution in the meniscus loses the fluidity of the meniscus, so the meniscus breaks up in its early stages and the advantage of reducing the occurrence of a mist is also obtained.

### (B) Second Embodiment

Now, a second embodiment of the present invention will be described in conjunction with the drawings.

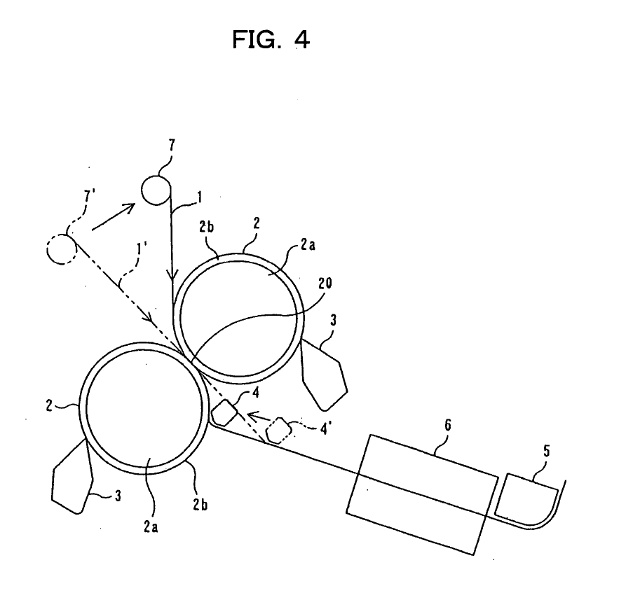

FIG. 4 shows a simplified side view of a coating apparatus constructed in accordance with the second embodiment of the present invention. In the figure, the same reference numerals as FIG. 1 denote the same parts and a description of these parts will be partly omitted.

As illustrated in FIG. 4, the coating apparatus of the second embodiment has the same mini turn bar 4 as the first embodiment to the downstream side of web-nipping portions 20. The coating apparatus further has the same guide roll (paper roll) 7 as the alteration of the first embodiment (see the two-dot chain line in FIG. 1) to the upstream side of the web-nipping portions 20.

In the second embodiment, the mini turn bar 4 is arranged so that the web 1 is wound around a lower applicator roll 2. The paper roll 7 is arranged so that the web 1 is wound around an upper applicator roll 2. However, the mini turn bar 4 and paper roll 7 may be arranged in reverse order with respect to the upper and lower applicator rolls 2,2.

In the second embodiment, a drier 6 and turn bar 5 are arranged to the downstream side of the applicator rolls 2,2 in the reverse order of the first embodiment. However, they are arranged properly in accordance with device-installation environment, etc.

And in the second embodiment, the mini turn bar 4 and paper roll 7 are provided with moving mechanisms (not shown), respectively. Because various moving mechanisms are well known in the prior art, a description of the detailed structures will not be given.

The mini-turn-bar moving mechanism is used to properly move the mini turn bar 4 in a direction away from or toward the applicator roll 2 or circumferential direction of the applicator roll 2 or combined direction of these directions (e.g., a direction from the position of reference numeral 4′ in FIG. 4 to the position of reference numeral 4). By moving the mini turn bar 4 in that direction, the contact length that the web 1 contacts one (lower) of the two applicator rolls 2 (i.e., the distance that the web 1 is held on the lower applicator roll 2) can be adjusted.

Also, the paper-roll moving mechanism is used to properly move the paper roll 7 in the required direction so that the angle at which the web 1 enters between the web-nipping portions 20 can be adjusted.

Since the coating apparatus of the second embodiment of the present invention is constructed as described above, the same advantages as the first embodiment can be obtained by applying a coating solution to the web 1 with the coating apparatus. In addition, the position of the mini turn bar 4 is adjusted with the mini-turn-bar moving mechanism, whereby the contact length that the web 1 that contacts one (lower) of the two applicators 2 can be adjusted. And the angle at which the web 1 enters between the web-nipping portions 20 is adjusted by adjusting the position of the paper roll 7 with the paper-roll moving mechanism, whereby the contact length that the web 1 contacts the other (upper) applicator roll 2 can be adjusted. Thus, the separation condition of the web 1 from one of the two applicator rolls 2 and coating conditions for both sides of the web 1 can be freely adjusted.

### (C) Third Embodiment

Now, a third embodiment of the present invention will be described in conjunction with the drawings.

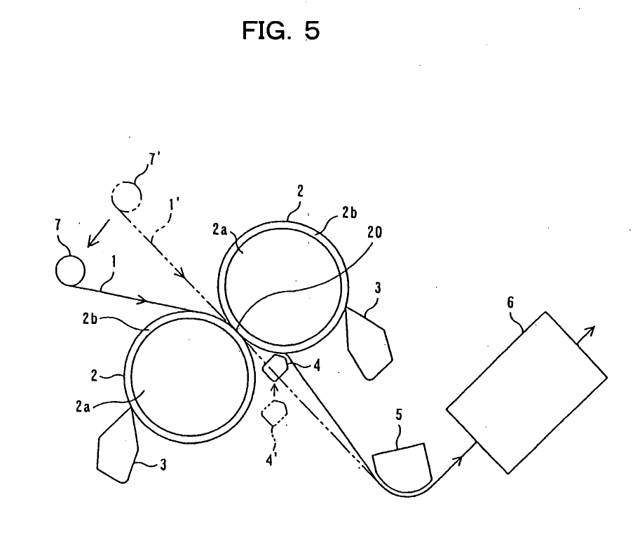

FIG. 5 shows a simplified side view of a coating apparatus constructed in accordance with the third embodiment of the present invention. In the figure, the same reference numerals as FIGS. 1 and 4 denote the same parts and a description of these parts will be partly omitted.

As illustrated in FIG. 5, the coating apparatus of the third embodiment has the same mini turn bar 4 as the second embodiment to the downstream side of web-nipping portions 20. The coating apparatus further has the same guide roll (paper roll) 7 as the second embodiment to the upstream side of the web-nipping portions 20.

In the third embodiment, the mini turn bar 4 is arranged so that the web 1 is wound around an upper applicator roll 2, and the paper roll 7 is arranged so that the web 1 is wound around a lower applicator roll 2. However, the mini turn bar 4 and paper roll 7 may be arranged in reverse order with respect to the upper and lower applicator rolls 2,2.

In the third embodiment, a turn bar 5 and drier 6 are arranged to the downstream side of the applicator rolls 2,2 in the recited order, as with the first embodiment. However, they are arranged properly in accordance with device-installation environment, etc.

And in the third embodiment, the same mini turn bar 4 and paper roll 7 as those of the second embodiment are provided with moving mechanisms (not shown), respectively.

The paper-roll moving mechanism is the same as that of the second embodiment. The mini-turn-bar moving mechanism is able to adjust the contact length that the web 1 contacts one (upper) of the two applicator rolls 2 (distance that the web 1 is held on one of the two applicator rolls) by moving the mini turn bar 4 in the diameter direction of the applicator roll 2. The mini-turn-bar moving mechanism is also able to move the mini turn bar 4 from the web 1 to the position indicated by reference numeral 4′ in FIG. 4.

Since the coating apparatus of the third embodiment of the present invention is constructed as described above, the same advantages as the second embodiment can be obtained by applying a coating solution to the web 1 with the coating apparatus. In addition, the mini turn bar 4 can be moved away from the path of the web 1, so working space can be ensured by moving the mini turn bar 4 away from the path of the web 1 during paper travel or maintenance of equipment. Thus, the advantage of enhancing operation efficiency is obtained.

The paper-roll moving mechanism may also be constructed so that it can move the paper roll 7 away from the path of the web 1 to enhance operation efficiency.

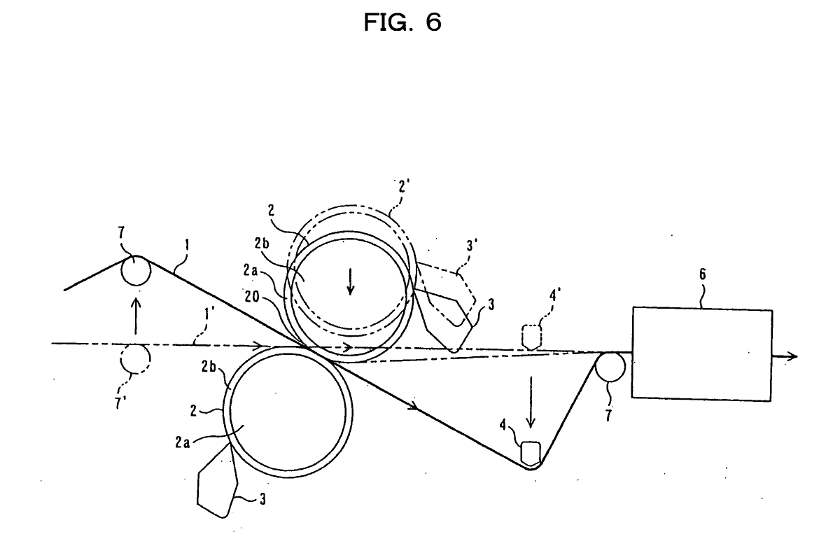

In the case where there is a need for the web 1 to travel horizontally for reasons such as an enhancement in the operation efficiency of paper passage, etc., there is an alteration such as the one shown in FIG. 6. Note that in the figure, the same reference numerals as FIGS. 1, 4, and 5 denote the same parts.

In this case, as illustrated in FIG. 6, one of the two applicator rolls 2 (e.g., an upper application roll in FIG. 6) is constructed so that it is movable in a direction away from and toward the web 1 (vertical direction in FIG. 6) at a position where the center axis of the upper applicator roll 2 is offset horizontally from the center axis of the other applicator roll 2 (e.g., a lower application roll in FIG. 6). By moving the upper applicator roll 2 from reference numeral 2′ to reference numeral 2 in an arrow-indicating direction and pressing the upper applicator roll 2 against the lower applicator roll 2, the web 1 can be wound around the lower applicator roll 2.

To adjust the length that the web 1 is wound around the lower applicator roll 2, there are provided a paper roll 7 and a paper-roll moving mechanism (not shown) to the side upstream of the applicator rolls 2. Also, there are provided an air-flotation type mini turn bar 4 and a mini-turn-bar moving mechanism (not shown) to the downstream side of the applicator rolls 2. Therefore, the paper roll 7 is movable from reference numeral 7′ to reference numeral 7 (see a arrow) and the mini turn bar 4 is movable from reference numeral 4′ to reference numeral 4 (see an arrow). The embodiment shown in FIG. 6 further includes a downstream paper roll (fixed position) 7, which is mounted between the mini turn bar 4 and drier 6.

In the above-described case, a coating solution on the applicator roll 2 is permeated into the web 1 while the web 1 is being held on the applicator roll 2, and the fluidity and tack strength diminish. Therefore, even if the separation angle α of the web 1 from the applicator roll 2 is small, the separation position of the web 1 from the applicator roll 2 becomes stable and the advantage of reducing the quantity of a mist is obtained.

Of course, the length that the web 1 is wound around one of the two applicator rolls 2 and the separation angle of the web 1 from the applicator roll 2 can be altered by adjusting the position of the applicator roll 2 and/or the position of the mini turn bar 4. Also, the length that the web 1 is wound around the other applicator roll 2 can be altered by adjusting the position of the upstream paper roll 7.

(D) Others

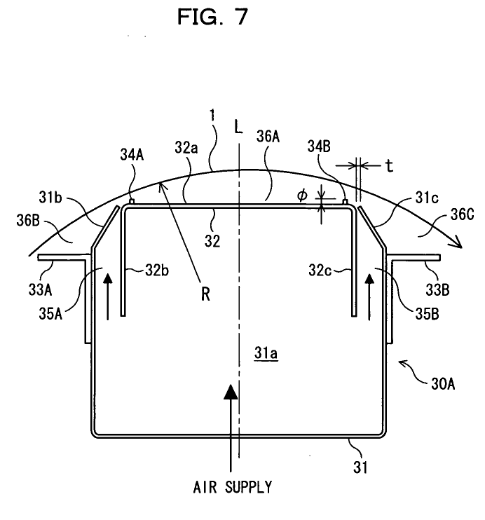

While the present invention has been described with reference to the preferred embodiments thereof, the invention is not to be limited to the details given herein, but may be modified within the scope of the invention claimed. For example, the structure of the mini turn bar (air-flotation type mini turn bar) used in the coating apparatus of the present invention is not limited to the structure shown in FIGS. 3A and 3B. Preferred examples are the structures of mini turn bars 30A, 30B, 30C, 30D, 30E, 30F, and 40 shown in FIGS. 7 to 13.

The mini turn bar 30A shown in FIG. 7 is a first preferred structure example. This mini turn bar 30A is equipped with a box-shaped main body 31 that has no cover. Compressed air from an air supply source (not shown) is supplied to the interior space 31a of the bar main body 31. The upper portions of the side walls 31b and 31c of the bar main body 31 diminish in width toward an opening, in which a U-shaped cover member 32 is arranged with its opening downward. Between the upstream side wall 31b and the cover member 32, there is provided an upstream gap (slit-shaped groove). The upstream gap serves as the exit of a first air nozzle 35A that is formed by the side wall 31b of the bar main body 31 and the side wall 32b of the cover member 32. Similarly, between the cover member 32 and the downstream side wall 31c, there is provided a downstream gap (slit-shaped groove). The downstream gap serves as the exit of a second air nozzle 35B that is formed by the side wall 32c of the cover member 32 and the side wall 31c of the bar main body 31.

In close proximity to the exits of the air nozzles 35A and 35B, partition members 34A, 34B in the form of a round bar are provided on the top surface 32a of the cover member 32 and extend in the width direction of the web 1. Also, L-shaped plates 33A, 33B are attached to the exterior surface of the side walls 31b, 31c of the bar main body 31 and extend in the width direction of the web 1. With this arrangement, between the air nozzles 35A and 35B there is formed a static pressure pocket (first air pocket) 36A that is defined by the partition members 34A, 34B and the top surface 32a of the cover member 32. Also, a static pressure pocket (second air pocket) 36B is formed to the upstream side of the air nozzle 35A and is defined by the upstream L-shaped plate 33A and the side wall 31b of the bar main body 31. Further, a static pressure pocket (third air pocket) 36C is formed to the downstream side of the air nozzle 35B and is defined by the downstream L-shaped plate 33B and the side wall 31C of the bar main body 31.

According to the mini turn bar 30A constructed as described above, the web 1 can be stably supported by both the dynamic pressure of compressed air that is squired out of the first and second air nozzles 35A, 35B and the static pressure of a layer of air within the first static pressure pocket 36A. Because the second and third static pressure pockets 36B, 36C are also provided at the inlet portion and outlet portion of the arcuately curved portion of the web 1, the flap of the web 1 against the mini turn bar 30A at the inlet and outlet portions can be suppressed by the static pressure of the air layers within the second and third static pressure pockets 36B, 36C. Thus, the web 1 can be prevented from contacting the mini turn bar 30A. As illustrated in FIG. 7, the shape of the mini turn bar 30A, which leads from the second static pressure pocket 36B on the inlet side to the third static pocket 36C on the outlet side, is symmetrically formed with respect to a center line L passing through the center of the first static pressure pocket 36A. Therefore, the web 1 is able to travel in a fixed radius of curvature and stable web travel becomes possible. Thus, according to the mini turn bar 30A, the web 1 is able to travel with a sufficient quantity of flotation and the problem of flaws in a coated surface due to contact can also be prevented.

In experiments using the mini turn bar 30A, in the case where the pressure of compressed air is 2000 mmAq (19.6 kPa) in gage pressure and the radius R of curvature of the web 1 is 160 mm, good results have been obtained when the slit width t of the exits of the air nozzles 35A, 35B is in a range of 0.5 to 5.0 mm and the diameter φ of the partition members 34A, 34B in a range of 1 to 10 mm. The radius R of curvature of the web 1 is determined by the shape of the mini turn bar 30A, and as the radius R of curvature becomes smaller, the reaction force that the mini turn bar 30A undergoes from the web 1 through a layer of air becomes greater. Since the mini turn bar 30A has along and narrow structure extending in the width direction of the web 1, it is preferable that the radius R of curvature be 100 mm or greater, if rigidity is taken into consideration.

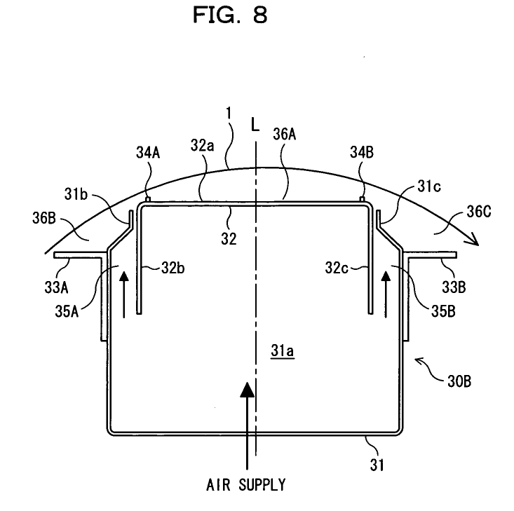

The mini turn bar 30B shown in FIG. 8 is a second preferred structure example. This mini turn bar 30B is an alteration of the first mini turn bar 30A. The side walls 31b, 31c of the bar main body 31 of the second mini turn bar 30B are partly different from the first mini turn bar 30A. That is, the upper portions of the side walls 31b, 31c of the bar main body 31, as with first example, diminish in width toward an opening, but the upper ends are vertically formed and are parallel to the side walls 32b, 32c of a cover member 32. With such a construction, the air-jet directions of air nozzles 35A, 35B in the second example are approximately parallel to a center line L, and as illustrated in FIG. 8, a second static pressure pocket 36B and third static pressure pocket 36C at the inlet and outlet portions can be made deeper than the first example.

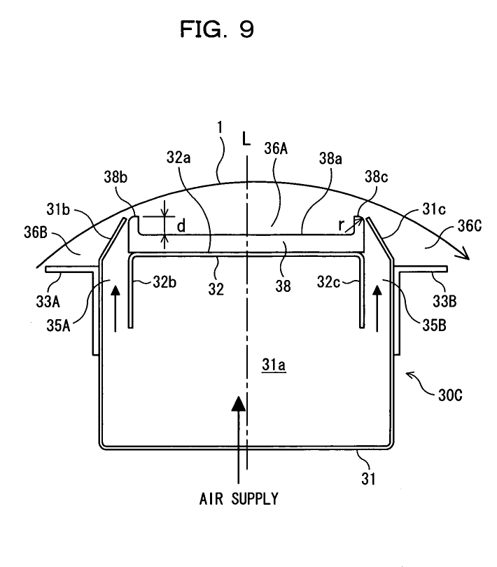

The mini turn bar 30C shown in FIG. 9 is a third preferred structure example. While the first mini turn bar 30A forms the static pressure pocket 36A by installing the partition members 34A, 34B in the shape of a bar on the top surface 32a of the cover member 32, the mini turn bar 30C of the third example is characterized in that a static pressure pocket 36A is formed by mounting a U-shaped plate 38 with left and right side walls 38b, 38c on the top surface 32a of a cover member 32. The U-shaped plate 38 is formed from a thick member, and the upper round corners of the left and right side walls 38b, 38c has a radius r of curvature, as shown in FIG. 9.

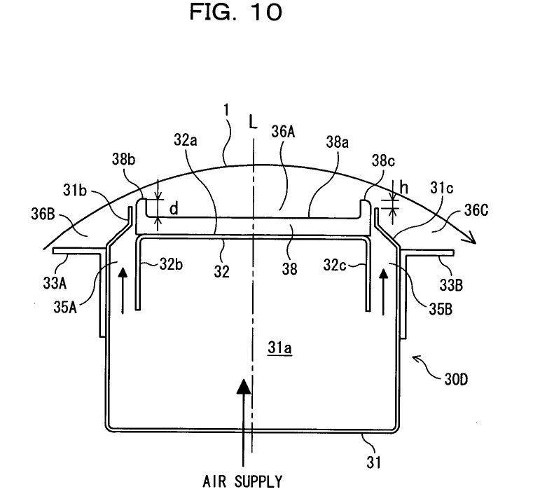

The mini turn bar 30D shown in FIG. 10 is a fourth preferred structure example. This mini turn bar 30D is an alteration of the third mini turn bar 30C, and the upper portions of the side walls 31b, 31c of a bar main body 31 are formed the same as the second example. In the third and fourth mini turn bars 30C and 30D, under the same conditions as the first example, good results have been obtained when the height d of the side walls 38b, 38c of the U-shaped plate 38 (pocket depth d) is 1 to 20 mm, the difference h in height between the side walls 38b, 38c of the U-shaped plate 38 and the side walls 31b, 31c of the bar main body 31 is −5 to 3 mm, and the radius r of curvature of the side walls 38b, 38c of the U-shaped plate 38 is 0.5 to 5 mm. The upper ends of the side walls 38b, 38c of the U-shaped plate 38 may be chamfered instead of being rounded.

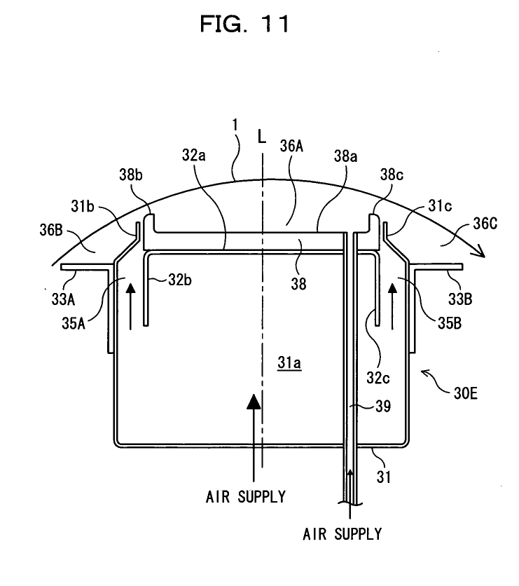

The mini turn bar 30E shown in FIG. 11 is a fifth preferred structure example. This mini turn bar 30E is an alteration of the fourth mini turn bar 30D, and within a static pressure pocket 36A, there is provided an air nozzle (third air nozzle) 39 from which compressed air is squirted. The air nozzle 39 has an opening in the top surface of a U-shaped plate 38 and is connected to an air supply source (not shown). The air supply source to which the third air nozzle 39 is connected may be the same system as an air supply source to which first and second air nozzles 35A, 35B are connected, or a different system. Preferably, the air supply system is constructed so that the third air nozzle 39 can squirt compressed air higher in pressure than the first and second air nozzles 35A, 35B.

The above-described mini turn bar 30E has the following advantages. That is, as the web 1 travels near the mini turn bar 30E, the air within the central static pressure pocket 36A passes over the side wall 38c of the U-shaped plate 38 that is the partition wall portion between the static pressure pockets 36A and 36C, and flows into the downstream static pressure pocket 36C. At this partition wall portion the web 1 is supported by the pressure of the wake air, but the flow passage area of the wake air at that partition wall portion widens gradually from the center static-pressure pocket 36A toward the downstream static-pressure pocket 36C, as shown in FIG. 11. Therefore, the dynamic pressure component of the wake air at the partition wall portion is gradually reduced as the flow passage area enlarges. Because of a reduction in the dynamic pressure of the wake air, if the pressure of the wake air becomes smaller than the tension of the web 1 or force of pushing the web 1 toward the mini turn bar 30E such as atmospheric pressure, etc., then the web 1 will contact the partition wall portion. However, in this mini turn bar 30E, the static pressure component of the wake air flowing out from the static-pressure pocket 36A is enhanced by compressed air squirted from the air nozzle 39, so a compensation for a reduction in the dynamic pressure can be made and contact between the web 1 and the partition wall portion can be prevented.

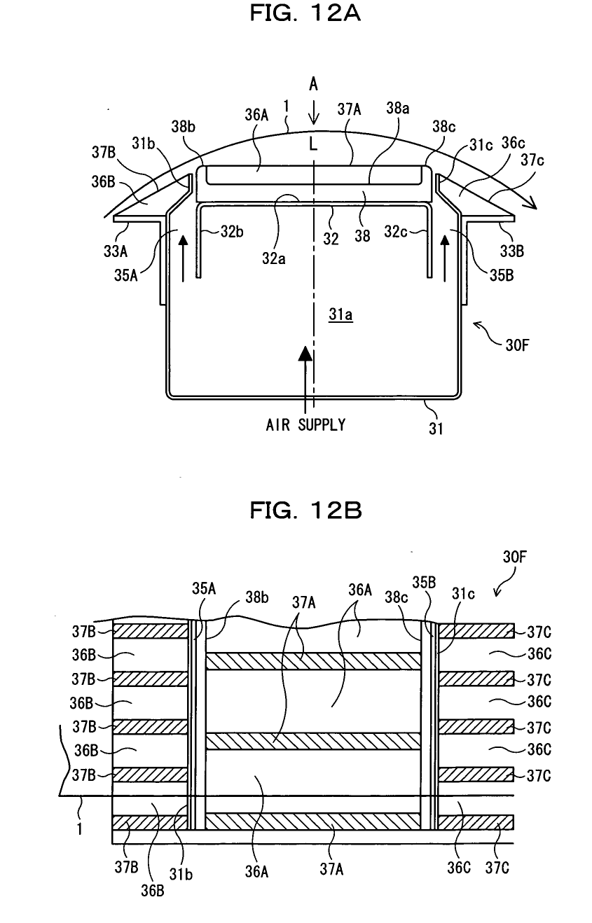

The mini turn bar 30F shown in FIGS. 12A and 12B is a sixth preferred structure example. This mini turn bar 30F is an alteration of the fourth mini turn bar 30D and is characterized in that there is provided a labyrinth structure in each of the static pressure pockets 36A, 36B, and 36C. That is, as shown in FIGS. 12A and 12B, the static pressure pockets 36A, 36B, and 36C are provided with a plurality of baffle plates (partition wall) 37A, 37B, and 37C, which are arranged at predetermined intervals in the longitudinal direction of the mini turn bar 30F (width direction of the web 1). The baffle plates 37A, 37B, and 37C segment each of the static pressure pockets 36A, 36B, and 36C into a plurality of sections.

According to the mini turn bar 30F, the baffle plates 37A, 37B, and 37C give strong resistance to air flowing between the web 1 and the mini turn bar 30F. That is, the baffle plates 37A, 37B, and 37C form a sort of labyrinth structure between the web 1 and the mini turn bar 30F. The labyrinth structure converts the kinetic energy of air into pressure, so the static pressure within each of the static pressure pockets 36A, 36B, and 36C rises. Also, when the web 1 shifts laterally, there is a possibility that pressure will leak from gaps formed in the width direction of the web 1, but since each of the static pressure pockets 36A, 36B, and 36C is segmented into a plurality of sections, a fluctuation in web-supporting pressure due to the lateral shift of the web 1 can be minimized. Therefore, the mini turn bar 30F is capable of supporting the web 1 more stably by such a labyrinth structure and preventing the web 1 from vibrating and making a noise. In the mini turn bar 30F, while each of the static pressure pockets 36A, 36B, and 36C is provided with a labyrinth structure, all the static pressure pockets 36A, 36B, and 36C does not always need to have a labyrinth structure. For instance, even when only the center static pressure pocket 36A has a labyrinth structure, the above-described advantages are obtained.

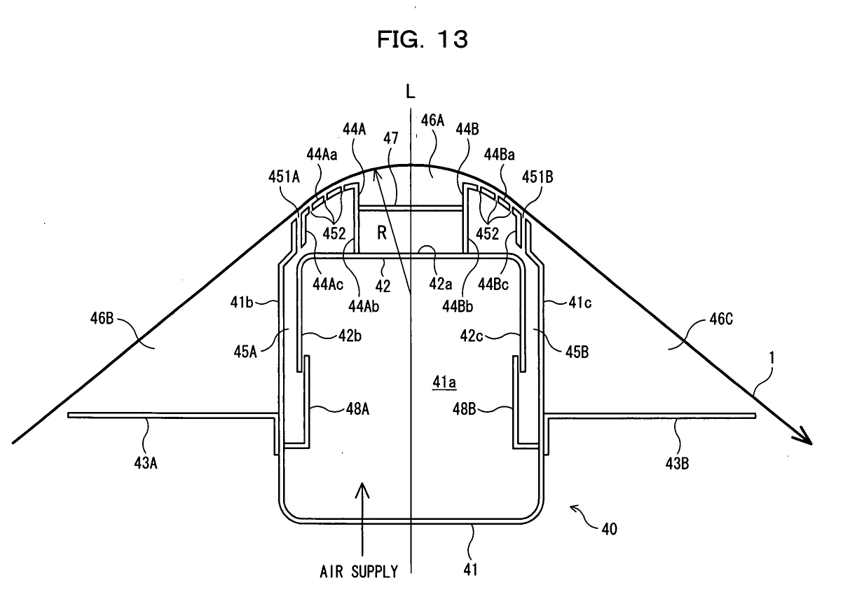

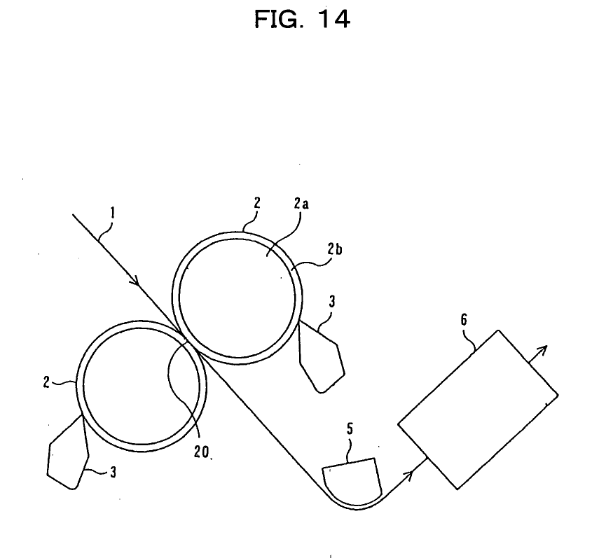

The mini turn bar 40 shown in FIG. 13 is a seventh preferred structure example. This mini turn bar 40 is equipped with a box-shaped main body 41 having no cover, and compressed air from an air supply source (not shown) is supplied to the interior space 41a of the bar main body 41. Within the opening of the bar main body 41, a U-shaped cover member 42 is arranged with its opening downward. Between the side walls 41b, 41c of the bar main body 41 and the side walls 42b, 42c of the cover member 42, there are formed passages 45A, 45B, which are in communication with the interior space 41a. These passages 45A, 45B serve as air nozzles that squirt compressed air out of the interior space 41a. They will hereinafter be referred to as air nozzles. L-shaped flange members 48A, 48B are attached to the interior surface of the side walls 41b, 41c of the bar main body 41, and between the upper ends of the flange members 48A, 48B and the lower ends of the side walls 42b, 42c of the cover member 42, the inlet portions of the first and second air nozzles 45A, 45B into which compressed air flows from the interior space 41a are narrowed down.

U-shaped partition members 44A, 44B are arranged left and right on the top surface 42a of the cover member 42 with their openings downward. The lower ends of the inner side walls 44Ab, 44Bb of the partition members 44A, 44B are mounted on the top surface 42a of the cover member 42, and between the lower ends of the outer side walls 44Ac, 44Bc and the top surface 42a of the cover member 42, there are formed gaps through which the interiors of the partition members 44A, 44B communicate with the air nozzles 45A, 45B. The side walls 41b, 41c of the bar main body 41 extend near the top surfaces 44Aa, 44Ba of the partition members 44A, 44B, and between the upper end portions of the side walls 41b, 41c of the bar main body 41 and the partition members 44A, 44B, there are formed slit-shaped grooves 451B and 451C extending in the width direction of the web 1. The top surfaces 44Aa, 44Ba of the partition members 44A, 44B are formed into curved surfaces, which correspond to the curved path of the web 1. The curved tope surfaces 44Aa, 44Ba have a great number of bores 452 arranged evenly in zigzags. The grooves 451B, 451C and bores 452 form the exits of the air nozzles 45A, 45B. The grooves 451B, 451C will hereinafter be referred to as air-jet grooves and the bores 452 will hereinafter be referred to as air-jet bores. Also, the top surfaces 44Aa, 44Ba of the partition members 44A, 44B in which the air-jet bores 452 are formed will hereinafter be referred to as air-jet surfaces.

The above-described partition members 44A, 44B form a static pressure pocket (first air pocket) 46A along with the top surface 42a of the cover member 42. Within the static pressure pocket 46A, there is arranged a reinforcement plate 47 through which both partition members 44A and 44B are connected. Also, L-shaped plates 43A, 43B are attached to the exterior surfaces of both side walls 41b, 41c of the bar main body 41 and extend in the width direction of the web 1. With this construction, a static pressure pocket (second air pocket) 46B, which is defined by the upstream L-shaped plate 43A and the side wall 41b of the bar main bar 41, is formed to the downstream side of the air nozzle 45A. Similarly, a static pressure pocket (third air pocket) 46C, which is defined by the downstream L-shaped plate 43B and the side wall 41C of the bar main bar 41, is formed to the upstream side of the air nozzle 45B.

According to the mini turn bar 40 with such a construction, the web 1 can be stably supported by both the dynamic pressure of the compressed air squired from the air nozzles 45A, 45B and the static pressure of the layer of air within the static pressure pocket 46A formed on the top surface 42a of the cover member 42. In addition, in this mini turn bar 40, the static pressure pockets 46B, 46C are provided at the inlet and outlet portions of the curved portion of the web 1, so the flap of the web 1 against the mini turn bar 40 at the inlet and outlet portions can be suppressed by the static pressure of the air layers formed within the static pressure pockets 46B, 46C, and the contact of the web 1 with the mini turn bar 40 can be prevented.

Also, as the web 1 travels near the mini turn bar 40, the air within the central static pressure pocket 46A passes over the partition member 44B that is the partition wall portion between the static pressure pockets 46A and 46C, and flows into the downstream static pressure pocket 46C. At this partition wall portion the web 1 is supported by the pressure of the wake air, but the flow passage area of the wake air widens gradually from that partition wall portion toward the downstream static-pressure pocket 46C. Therefore, the dynamic pressure component of the wake air at the partition wall portion is gradually reduced as the flow passage area enlarges. Because of a reduction in the dynamic pressure of the wake air, if the pressure of the wake air becomes smaller than the tension of the web 1 or force of pushing the web 1 toward the mini turn bar 40 such as atmospheric pressure, etc., then the web 1 will contact the baffle wall portion. However, in this mini turn bar 40, the top surface 44Ba of the partition member 44B that is the partition wall portion is used as the air-jet surface, so contact between the web 1 and the partition member 44B can be prevented by a layer of compressed air that is squired out of the air-jet surface 44Ba. Also, by forming the air-jet groove 451B on the downstream side of the air-jet surface 44Ba, a curtain of compressed air from the air-jet groove 451B can prevent the air squirted out of the air-jet surface 44Ba from leaking out as the web 1 travels, and a layer of air can be reliably formed between the web 1 and partition member 44B.

Moreover, the shape of the mini turn bar 40, which leads from the upstream static pressure pocket 46B to the downstream static pocket 46C, is symmetrically formed with respect to a center line L passing through the center of the center static pressure pocket 46A, so the web 1 is able to travel in a fixed radius of curvature and stable travel of the web 1 becomes possible.

According to these mini turn bars 30A, 30B, 30C, 30D, 30E, 30F, or 40, the web 1 is able to travel stably with a sufficient quantity of flotation without contacting the mini turn bar. Therefore, if a coating solution is applied to the web 1 by the coating apparatus equipped with the mini turn bar 30A, 30B, 30C, 30D, 30E, 30F, or 40, the quality of the coated paper can be further enhanced.

Also, the respective characteristic constructions of the mini turn bars 30A, 30B, 30C, 30D, 30E, 30F, and 40 can be combined together. For instance, the labyrinth structure of the six mini turn bar 30F can be provided in the other mini turn bars 30A, 30B, 30C, 30D, 30E, and 40. The third air nozzle 39 of the fifth mini turn bar 30E can also be provided in the other mini turn bars 30A, 30B, 30C, 30D, 30F, and 40.

1. An apparatus for transferring and applying a film of coating solution on each of two applicator rolls to each side of a web as it passes between nipping portions of said two applicator rolls which are formed when they are pressed against each other, said apparatus comprising:
an air-flotation type turn bar, provided to the downstream side of said nipping portions, for conveying said web while holding said web on a surface of one of said two applicator rolls, after said web passes between said nipping portions.

2. The apparatus as set forth in claim 1, further comprising:
a mechanism for moving said turn bar.

3. The apparatus as set forth in claim 2, wherein said turn-bar moving mechanism is constructed to adjust a distance that said web is held on said one applicator roll.

4. The apparatus as set forth in claim 2, wherein said turn-bar moving mechanism is constructed to adjust a distance between said one applicator roll and said turn bar.

5. The apparatus as set forth in claim 1, further comprising:
a paper roll, provided to the upstream side of said nipping portions, for conveying said web while holding said web on a surface of the other of said two applicator rolls, before said web passes between said nipping portions.

6. The apparatus as set forth in claim 5, further comprising:
a mechanism for moving said paper roll.

7. An air-flotation type turn bar for causing a web to travel so as to form an arcuately curved portion around said bar by floating said web with air, comprising:
a first air pocket arranged inside the arcuately curved portion of said web;
a second air pocket provided adjacent to said first air pocket and arranged near an entrance portion of said curved portion;
a third air pocket provided adjacent to said first air pocket and arranged near an exit portion of said curved portion;
a first air nozzle provided between said first air pocket and said second air pocket for squirting air toward said web; and
a second air nozzle provided between said first air pocket and said third air pocket for squirting air toward said web.

8. The air-flotation type turn bar as set forth in claim 7, further comprising:
a third air nozzle for squirting higher-pressure air than atmospheric pressure into said first air pocket.

9. The air-flotation type turn bar as set forth in claim 7, further comprising:
a plurality of first baffle walls provided in the direction of the width of said web within said first air pocket so that said first air pocket is segmented into a plurality of sections.

10. The air-flotation type turn bar as set forth in claim 9, further comprising:
a plurality of second baffle walls provided in the direction of the width of said web within said second air pocket so that said second air pocket is segmented into a plurality of sections; and
a plurality of third baffle walls provided in the direction of the width of said web within said third air pocket so that said third air pocket is segmented into a plurality of sections.

11. The air-flotation type turn bar as set forth in claim 7, wherein:
said second air nozzle comprises a second air-jet surface and a second slit-shaped air-jet groove, provided on a third surface extending in the direction of the width of said web;
said second air-jet surface has a great number of air-jet bores and is provided near said first air pocket; and
said second air-jet groove extends in the direction of the width of said web and is provided near said third air pocket.

12. The air-flotation type mini turn bar as set forth in claim 11, wherein:
said first air nozzle comprises a first air-jet surface and a first slit-shaped air-jet groove, provided on said third surface extending in the direction of the width of said web;
said first air-jet surface has a great number of air-jet bores and is provided near said first air pocket; and
said first air-jet groove extends in the direction of the width of said web and is provided near said second air pocket.

13. The air-flotation type mini turn bar as set forth in claim 7, wherein a shape from said second air pocket to said third air pocket is formed symmetrically with respect to a center line of said first air pocket.

14. An apparatus for transferring and applying a film of coating solution on each of two applicator rolls to each side of a web as it passes between nipping portions of said two applicator rolls which are formed when they are pressed against each other, said apparatus comprising:
the air-flotation type turn bar as set forth in claim 7, provided to the downstream side of said nipping portions for conveying said web while holding said web on a surface of one of said two applicator rolls after said web passes between said nipping portions, by air squirted from said bar.

15. A method of transferring and applying a film of coating solution for coated paper production on each of two applicator rolls to each side of a web as it passes between nipping portions of said two applicator rolls which are formed when they are pressed against each other, said method comprising the step of:
conveying said web while holding said web on a surface of one of said two applicator rolls after said web passes between said nipping portions, by an air-flotation type turn bar.
